(19) United States
(12) Patent Application Publication
(10) Pub. No.: US 2025/0133344 A1
(43) Pub. Date: Apr. 24, 2025

(54) Diaphragm for Speaker

(71) Applicant: Glass Acoustic Innovations Co., Ltd., New Taipei City (TW)

(72) Inventors: Kwun Kit CHAN, New Taipei City (TW); Yi Feng WEI, New Taipei City (TW); Chien-Hsing CHU, New Taipei City (TW); Ching-Yu HSIEH, New Taipei City (TW)

(21) Appl. No.: 18/905,346

(22) Filed: Oct. 3, 2024

(30) Foreign Application Priority Data
Oct. 18, 2023 (TW) 112139765

(51) Int. Cl. H04R 7/10

(52) U.S. Cl. CPC H04R 7/10; H04R 2307/023

(57) ABSTRACT

The present invention discloses a diaphragm for a speaker including a lower surface area, a central area formed on said lower surface area, an upper surface area formed on said central area. The upper surface area, the central area and the lower surface area includes homogeneous amorphous materials. The diaphragm includes internal stress changing with a depth from the surface to the center of the diaphragm.

### BACKGROUND

### 1. Technical Field

The present invention relates to a speaker, and more particularly, a speaker diaphragm.

### 2. Related Art

Speakers mainly comprise a magnet component, a sound coil partially or completely located within the magnet component. A sound radiation diaphragm is mechanically attached to the sound coil. It typically includes, in most cases, other supporting components such as diaphragm surround, spider (or suspension), frame, etc. The magnetic field is generated by flowing the alternating current through the coils (sounding coils), the coils vibrate due to the interaction between the magnetic field and the current according to Fleming's law, thereby vibrating the attached diaphragm as well. Since the propagation, absorption (attenuation) and reflection of the sound are frequency-dependent and are nonlinear. The sound is radiated from the entire diaphragm area in a very complex pattern. Therefore, the material, manufacture, shape and other characteristics of the diaphragm greatly affect the sound quality of the speaker.

### SUMMARY

The object of the present invention is to provide the diaphragm for the speaker. The diaphragm includes an upper surface area, a central area and a lower surface area. The upper surface area, the central region and the lower surface region are made of homogeneous amorphous material, preferably, the homogeneous amorphous material includes silicon dioxide. The homogeneous amorphous diaphragm includes stress distribution as a function of depth from the surface to the center of the diaphragm.

In one embodiment, the thickness of the diaphragm is less than or equal to 50 microns and greater than or equal to 0.1 microns, the thickness of the upper surface area is less than or equal to 20 microns and greater than or equal to 0.01 microns, and the thickness of the central area is less than or equal to 49.9 microns and greater than or equal to 0.02 microns, and the thickness of the lower surface area is less than or equal to 20 microns and greater than or equal to 0.01 microns. The part or all of the upper surface area or the lower surface area has a rough surface for reducing surface acoustic wave reflection and reducing the weight of the diaphragm. A coating layer is formed on part or all of the upper surface area, the lower surface area or the combination thereof for increasing the damping of the diaphragm. The coating layer is formed of aluminum, nickel, copper, diamond, resin or polymer.

In one embodiment, the diaphragm includes: a flat area and at least two sides located on different sides of the flat area. The two sides are bent to form a curved area respectively. Each side of the flat area is therefore curved into a corresponding curved area.

In one embodiment, the diaphragm includes a continuous wave structure, the amplitude D of the wave structure is equal to or greater than 1/10 of the thickness of the diaphragm, and the peak-to-peak length λ is equal to or greater than 2 times the thickness of the diaphragm.

### BRIEF DESCRIPTION OF THE DRAWINGS

FIG. 1A is a cross-sectional view of the diaphragm of the present invention.

FIG. 1B is a cross-sectional view of the diaphragm of the present invention.

FIG. 2A is a cross-sectional view of the diaphragm of the present invention.

FIG. 2B shows the diaphragm according to the present invention.

FIG. 2C shows the diaphragm of the present invention.

FIG. 2D shows the diaphragm of the present invention.

FIG. 2E shows the diaphragm of the present invention.

FIG. 2F shows the diaphragm of the present invention.

FIG. 3A is a cross-sectional view of the diaphragm of the present invention.

FIG. 3B shows the diaphragm of the present invention.

FIG. 4 shows the diaphragm of the present invention.

FIG. 5A shows the side view of the diaphragm of the present invention.

FIG. 5B shows the side view of the diaphragm of the present invention.

FIG. 5C shows the side view of the diaphragm of the present invention.

FIG. 5D shows the side view of the diaphragm of the present invention.

FIG. 5E shows the side view of the diaphragm of the present invention.

FIG. 5F shows the diaphragm of the present invention.

FIG. 5G shows the diaphragm of the present invention.

FIG. 5H shows the diaphragm of the present invention.

FIG. 5I shows the diaphragm of the present invention.

FIG. 6A is a cross-sectional view of the diaphragm of the present invention.

FIG. 6B is a cross-sectional view of the diaphragm of the present invention.

FIG. 7A shows the diaphragm of the present invention.

FIG. 7B shows the diaphragm of the present invention.

FIG. 8 shows part of the speaker structure of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The present invention provides novel feature through different aspects for the diaphragm of the speaker.

The energy typically decays when the sound propagates from one medium to another medium, especially the sound velocity or acoustic-impedance in the two mediums is different, even if the two mediums have the same density. Appropriate energy-loss is beneficial to the quality of the sound. Therefore, this present invention employs this feature to construct the diaphragm of the speaker.

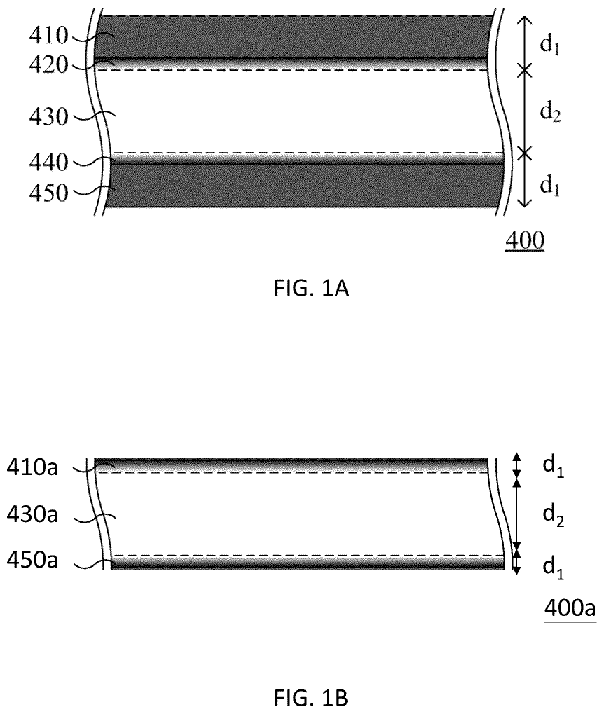

As shown in FIG. 1A, the candidate material selected for the diaphragm 400 is hard homogeneous amorphous material with gradient stress. The material that meets such characteristics includes silicon dioxide. Specifically, the glass is made of silica, followed by cutting into appropriate sizes, thereafter, the glass is treated by heat to strengthen its toughness, thereby completing the processes of forming the strengthened glass. The tempered glass meets the requirements of the material for this embodiment. The material is homogeneous with gradual stress and it is in the amorphous state. Any other materials with the aforementioned requirements could be used for the diaphragm. In one case, the diaphragm 400 includes upper surface area 410 as shown in FIG. 1A, it also includes upper transition area 420, central area 430, lower transition area 440 and lower surface area 450. It should be noted that the upper surface area 410, the upper transition area 420, the central area 430, the lower transition area 440 and the lower surface area 450 are all in this hard homogeneous amorphous material with gradient stress characteristic.

The upper surface area 410, the upper transition area 420, the center area 430, the lower transition area 440 and the lower surface area 450 of the diaphragm 400 are all made of the same hard homogeneous amorphous material, specifically, the internal stresses of each area are different. The different stresses will cause different sound velocity or acoustic-impedance when the sound propagate therein. Therefore, the physical vibration characteristics are slightly different in these areas to achieve proper energy-loss and better sound quality. In General, the internal stresses in the upper surface area 410 and the lower surface area 450 are both compressive stresses and they have similar energy intensities, while the internal stresses in the central area 430 are tensile stress (tension stress). The internal stress in the upper transition region 420 located between the central region 430 and the upper surface region 410 is not constant, it gradually changes with the distance from the upper surface region 410, thereby varying the stress from compressive to tension stress. The boundary of the upper transition area 420 in this diagram is expressed as a dotted line, the boundary in reality is not obvious or even does not exist. Therefore, the compressive stress magnitude at the junction of the upper transition region 420 and the upper surface region 410 is very close, or even equal to the stress of the upper surface region 410, while the tension stress magnitude at the junction between the upper transition region 420 and the central region 430 is very close as well, or even equal to the tension internal stress of the central region 430. Similarly, the internal stress in the lower transition area 440 is variable value, it gradually changes with the distance from the lower surface area 450 from compressive stress to tension stress. Similarly, the boundary of the lower transition area 440 is also expressed as the dotted line, as aforementioned, the boundary is not obvious or even does not exist. Therefore, the compression stress at the junction of the lower transition region 440 and the lower surface region 450 is closes to or even equal to the compression internal stress of the lower surface region 450, while the tension stress at the interface of the lower transition region 440 and the central region 430 is also close to or even equal to the magnitude of the tension internal stress of the central region 430. The better sound quality is achieved by above gradient compression-tension boundaries that gradually change from compressive stress to tension stress.

Furthermore, in order to provide excellent vibration characteristics, the overall thickness of the diaphragm 400 is preferably about 0.1 micrometer (μm) to 50 micrometers. Specifically, the total thickness d1 of the upper surface area 410 and the upper transition area 420 is preferably about 0.01 microns to 20 microns, and the total thickness d1 of the lower surface area 450 and the lower transition area 440 is also about 0.01 microns to 20 microns, as for the thickness d2 of the central region 430, it is preferably about 0.02 microns to 49.9 microns.

Please refer to FIG. 1B, in order to apply the aforementioned diaphragm with hard homogeneous amorphous material to the fields of mini, small speakers and microphones, such as earphones or mobile phone microphones, the thickness of the diaphragm 400a is preferably controlled in the range of 0.1-50 micrometers (μm).

FIG. 1B shows a thinned diaphragm structure. The diaphragm 400a includes the upper surface area 410a, the central area 430a, and the lower surface area 450a. The upper surface area 410a, the central area 430a and the lower surface area 450a are all formed by hard homogeneous amorphous material. Specifically, the thickness d1 of the upper surface area 410a is preferably about 0.01 microns to 20 microns, the thickness d1 of the lower surface area 450a is also preferably about 0.01 microns to 20 microns, and the thickness d2 of the central area 430 is about 0.02 microns to 49.9 microns.

According to one embodiment of the present invention, the method of manufacturing the diaphragm 400a includes steps of forming glass by silicon dioxide through fusion/pull-down glass manufacturing technology, thinning the thickness of the glass through etching, and followed by performing a strengthening process to form a thin film diaphragm. The diaphragm 400a, which is thinned by etching, has a roughened surface.

According to another embodiment of the present invention, a part or all of the upper surface area 410a, a part or all of the lower surface area 450a or the combination thereof is etched to increase the surface area to reduce surface sound wave reflection and reduce weight.

According to another embodiment of the present invention, the tempered glass meets the material requirements of the present invention, it is hard and homogeneous. It is also amorphous material. Each layer 410a, 430a, and 450a of the diaphragm 400a includes substantially the same hard homogeneous amorphous material with internal stress which changes with the distant from the surface to the center depth of the diaphragm 400a (i.e. it changes with the distribution of guest ions during the glass strengthening process).

According to further embodiment of the present invention, one or both of the upper surface area 410a, and the lower surface area 450a of the diaphragm 400a is coated with a layer. The layer could be formed on a part or all of the one or both of the surface areas. The layer is coated to increase the damping of the diaphragm by using aluminum, nickel, copper, diamond, resin or polymer films.

Some embodiments of the novel diaphragm provided by the present invention are explained by above diaphragm characteristics, structures and materials, and shown by following cross-sectional views of the diaphragm.

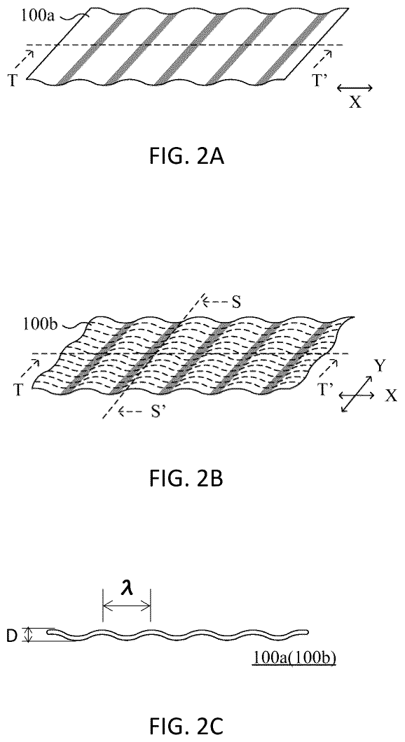

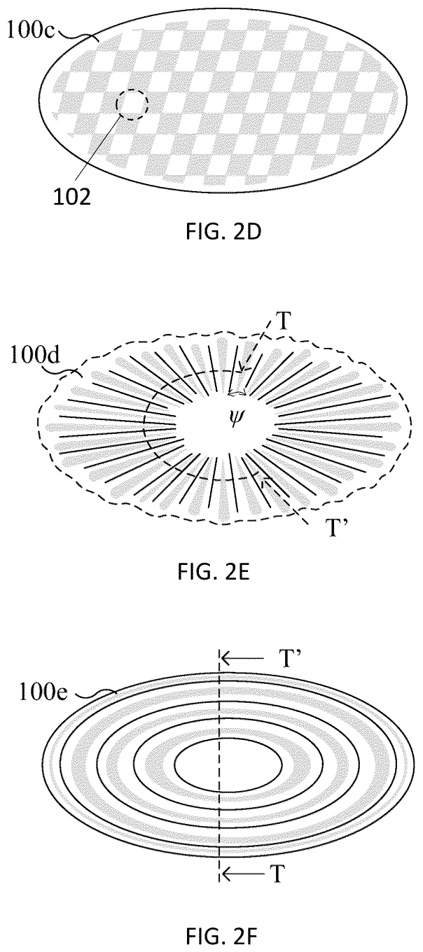

Please refer to FIG. 2A, which is a cross-sectional view of the diaphragm according to an embodiment of the present invention. In this embodiment, the material of the diaphragm is provided by the means as shown in FIG. 1. In the embodiment, the cross section of the diaphragm 10 is a continuous wave shape. During production, the diaphragm can be made into any various shapes. For example, the diaphragm 100a shown in FIG. 2B is a rectangular diaphragm with continuity and an undulating shape along a specific axis (x-axis). The wave shape edge of the diaphragm appropriately reduces the wave amplitude of the area connected to the voice coils. The wavelength can be appropriately extended. The area connected between the diaphragm 100a and the coils could be made into a flat shape to facilitate the connection between the diaphragm 100a and other components in the speaker. The cross-sectional shape indicated by the line TT′ presents a continuous wave shape which is similar to that shown in FIG. 2A. As another example, the diaphragm 100b shown in FIG. 2C is a square diaphragm with continuity and an undulating shape along two different specific axes (X-axis and Y-axis in FIG. 2C). Similarly, the wave amplitude at its edge or the area used to connect to the voice coil is appropriately reduced, and the wave wavelength of there is appropriately extended. Alternatively, it could be formed into a flat shape to facilitate the connection between the diaphragm 100b and other components in the speaker. Furthermore, the cross-sectional shape indicated by line TT′ shows a continuous wave shape similar to that shown in FIG. 2A. In one embodiment, the continuous wave-like structure of the diaphragm exhibits an amplitude D (see FIG. 1) equal to or greater than 1/10 of the total thickness of the diaphragm (2×d1+d2), and the peak-to-peak wave length λ is equal to or greater than 2 times the total thickness of the diaphragm (2×d1+d2), please see FIG. 1.

It should be noted that although the overall appearance of the diaphragm 100a and the diaphragm 100b of FIG. 2B and FIG. 2C is square, in different situations, the appearance can also be made into other shapes, such as a racetrack-shaped (obround, racetrack), circular or oval shape diaphragms without holes.

For related examples, please refer to FIG. 2D. The diaphragm 100c shown has continuous waves and they undulate along two different specific axes (X-axis and Y-axis in FIG. 2D). Two areas indicated by shadows and light areas in the circular diaphragm are interlaced and they represent the undulating surface along two directions. The pixel size 102 of each interlaced shadow and light area is equal to or greater than 2 times the total thickness of the diaphragm (2×d1+d2). Similarly, the amplitude D of the continuous wave structure of the diaphragm is equal to or greater than 1/10 of the total thickness of the diaphragm (2×d1+d2), and the peak-to-peak length λ is equal to or greater than 2 times the total thickness of the diaphragm (2×d1+d2). In addition to square or rectangle shape, shadows and bright areas can also be more complex shapes such as regular hexagons. Similarly, the wave amplitude at its edge or the area used to connect to the voice coil is appropriately reduced, the wave wavelength is appropriately extended as well. Alternatively, the edge can be formed by flat shape as shown in the figures, and the flat edge will be beneficial to the diaphragm 100c for engaging with other components in the speaker.

The diaphragm 100d shown in FIG. 2E is a circular diaphragm with continuous waves which undulates along the circumferential direction (denoted by line TT′). In one embodiment, the azimuthal angle ψ (the unit wavelength of the continuous wave structure) of each continuous wave structure may range between 0.1 and 180 degrees. Similarly, the amplitude D of the continuous wave structure of the diaphragm is equal to or greater than 1/10 of the total thickness of the diaphragm (2×d1+d2), and the peak-to-peak length λ is equal to or greater than 2 times the total thickness of the diaphragm (2×d1+d2). The above-mentioned diaphragms all have the cross-section shape of FIG. 2A in certain directions (direction of the line TT′), and they can also be introduced into the embodiments of the diaphragm having the cross-section shape of FIG. 2A. The diaphragm 100e shown in FIG. 2F is a circular diaphragm with the continuous wave structure and they undulate along the radial direction. In one embodiment, the continuous wave structure of the diaphragm exhibits an amplitude D equal to or greater than 1/10 of the total thickness of the diaphragm (2×d1+d2), and the peak-to-peak length λ is equal to or greater than 2 times the total thickness of the diaphragm (2×d1+d2). Furthermore, in addition to the flat shape as shown in the figure, the diaphragm 100d of FIG. 2E and the diaphragm 100e of FIG. 2F can also be made into other shapes according to different demands, such as cone or dome shape.

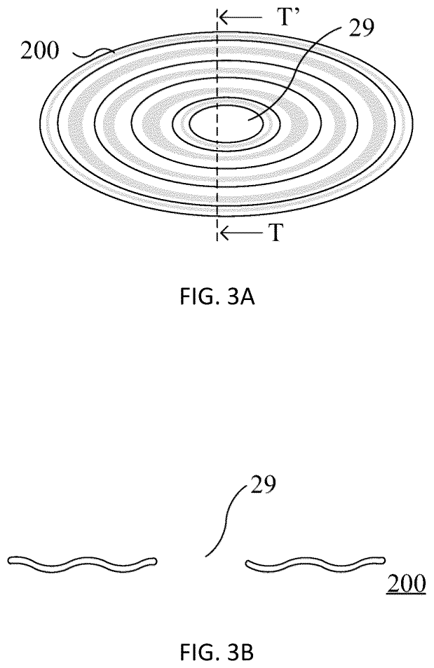

Please refer to FIG. 3A, it shows a cross-sectional view of a diaphragm according to another embodiment of the present invention. In this embodiment, the cross section of the diaphragm 20 also presents the continuous wave shape, but a certain portion is hollowed out to form a cavity 29 in the area where the diaphragm is connected to the voice coil. The cavity 29 may also be formed in the areas (connected to the voice coil) of the diaphragm 100a shown in FIG. 2B, the diaphragm 100b shown in FIG. 2C, the diaphragm 100c shown in FIG. 2D, and the diaphragm 100e shown in FIG. 2F. It is possible to modify the diaphragm of FIG. 2B-2F to have the cross-sectional view of the diaphragm shown in FIG. 3A. For example, please refer to FIG. 3B. The diaphragm 200a is formed by digging a cavity 29 in the diaphragm 100e shown in FIG. 2F. The diaphragm 100a shown in FIG. 2B, the diaphragm 100b shown in FIG. 2C, and the diaphragm 100c shown in FIG. 2D can also be processed by the similar method to form the diaphragm having similar cross section as shown in FIG. 3A.

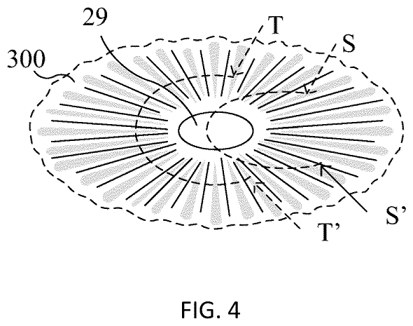

In addition, the cavity 29 may also be made in the area where the diaphragm 100d and the voice coil are connected as shown in FIG. 2E, thereby obtaining the diaphragm 300 as shown in FIG. 4. From one point of view, in the diaphragm 300, the cross-sectional shape along the cross-sectional line TT′ is the same as that shown in FIG. 2A, from another point of view, if the cross-sectional line TT′ is moved laterally to the cross-sectional line SS′ position, the shape of the cross-section obtained is similar to the one shown in FIG. 3A.

Overall, there are two possibilities for the diaphragm provided in this embodiment: one is the continuous wave shape, on the other hand, the continuous wave is interrupted by the hole or cavity formed between the diaphragm and the sound coil.

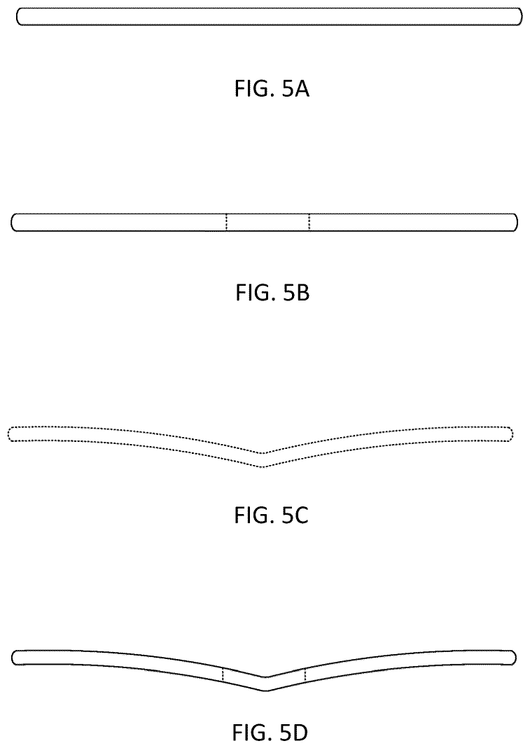

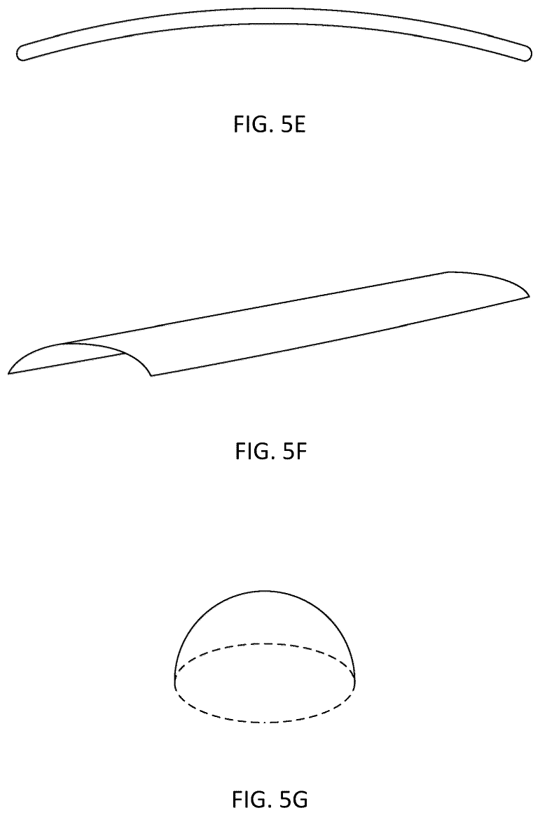

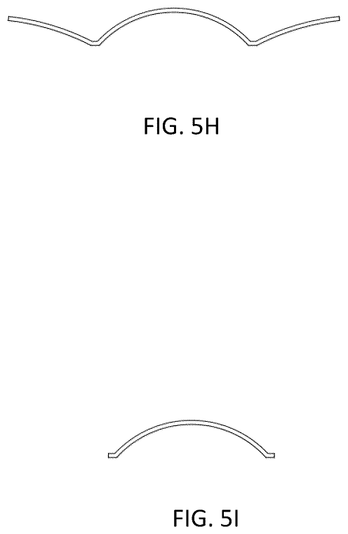

The cross-sectional shape of the diaphragm made by the above structure can be various shapes, for example: the flat shape as shown in FIG. 5A, the flat shape with a cavity (area surrounded by dotted lines) as shown in FIG. 5B, the cone shape as shown in FIG. 5C, the cone shape with a cavity (area surrounded by dotted lines) as shown in FIG. 5D, a tunnel shape as shown in FIG. 5E-5F, the dome shape as shown in FIG. 5G, and the dome shape with wing structure as shown in FIG. 5H-5I, etc. The small area on the diaphragm surface includes the continuous wave structure surface as shown in the FIG. 2A, or the continuous wave structure surface with holes as shown in FIG. 3A.

Therefore, the outer edge shape of the diaphragm made with the above structure can be the following shapes when viewed from above, for example: circular, rectangular, elliptical (Oval/Elliptical), oblong (Obround), polygon or any other irregular shape. In one embodiment, the outer edge shape of the dome shape diaphragm is formed with the rectangular shape, the three-dimensional view of the overall appearance is as shown in FIG. 5F. If the outer edge shape of the dome shape diaphragm is in the form of a circle, the three-dimensional view of the overall appearance is as shown in FIG. 5G.

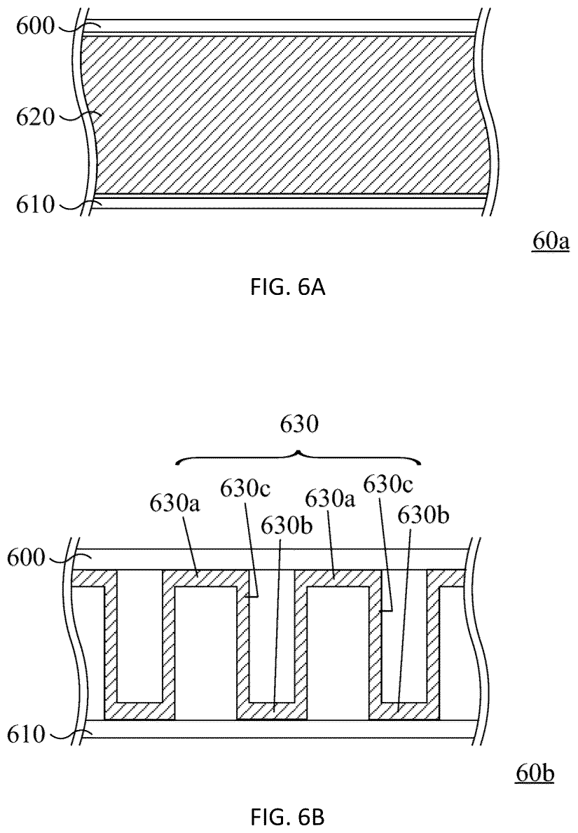

In addition to the above structure, the diaphragm structure in FIG. 1 and other materials can also be used to construct a composite diaphragm structure. Please refer to FIG. 6A, it shows the cross-sectional structural view of the composite diaphragm of the present invention. As shown in the figure, the composite diaphragm 60a includes a first diaphragm 600, a second diaphragm 610, and a low-density core layer 620 disposed between the first diaphragm 600 and the second diaphragm 610. At least one of the first diaphragm 600 and the second diaphragm 610 is made of the hard homogeneous amorphous material with gradient stresses as the diaphragm 400 disclosed in FIG. 1. In alternative embodiment, only one of the first diaphragm 600 or the second diaphragm 610 is made of the hard homogeneous amorphous material with gradual stress. In another case, both first and the second diaphragms 600, 610 are formed of the homogeneous amorphous material with gradual stress. When only one is the homogeneous amorphous material, the other diaphragm is made of, for example, the aluminum foil, polymer film or carbon fiber.

In addition, the low-density core layer 620, the first diaphragm 600 and the second diaphragm 610 are bonded together through adhesion, and the low-density core layer 620 can be made of, for example: polymethacrylimide foam (PMI form), balsa wood, epoxy with glass microspheres filler, and so on. The density of low-density core layer 620 is lower than the ones of the first diaphragm 600 and the second diaphragm 610, thereby reducing the overall weight of the composite diaphragm 60a.

Next, please refer to FIG. 6B, which is a cross-sectional view of a diaphragm of the present invention. The diaphragm 60b shown in FIG. 6B has the first diaphragm 600 and the second diaphragm 610 similar to the diaphragm 60a shown in FIG. 6A, therefore, the description is omitted. The difference from FIG. 6A is that there is a corrugated structure (corrugated core) 630 disposed between the first diaphragm 600 and the second diaphragm 610 in the diaphragm 60b. As shown in FIG. 6B, the corrugated structure 630 has a plurality of first side support bodies 630a, a plurality of second side support bodies 630b, and a plurality of connection structures 630c. The first side support body 630a is bonded to the first diaphragm 600 through adhesion, and the second side support body 630b is bonded to the second diaphragm 610 through adhesion as well. Each connection structure 630c connects the first side support body 630a and the second side support body 630b to ensure that there is sufficient space between the first side support body 630a of the corrugated structure 630 and the second diaphragm 610, or there is sufficient space between the second side support 630b of the corrugated structure 630 and the first diaphragm 600. Furthermore, the corrugated structure 630 may be made of materials such as aluminum foil, paper or polymer film.

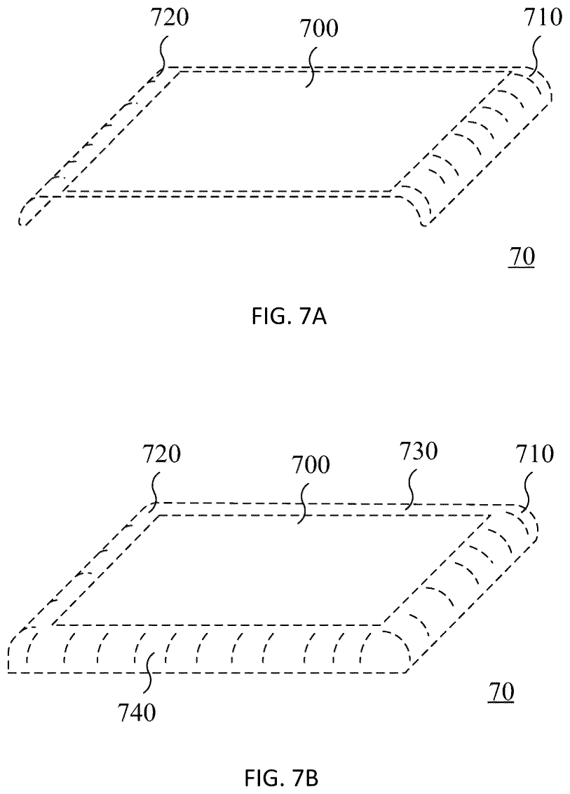

Please refer to FIG. 7A, which is the schematic diagram of the appearance of a diaphragm according to yet another embodiment of the invention. The above-described diaphragm structure (for example, diaphragm shown in FIGS. 1 and 6) can be applied to the embodiment. The diaphragm 70 has a flat area 700 in the center, and curved areas 710 and 720 located on opposite sides of the flat area 700. In another embodiment, referring to FIG. 7B, in addition to the curved regions 710 and 720, the diaphragm 70 also has curved areas 730 and 740 located on opposite sides of another set of the flat regions 700. Due to the thinner and lighter vibration mode, warping will inevitably occur when the area increases. Therefore, the existence of the curved areas 710, 720, 730 or 740 can appropriately enhance the overall stiffness of the diaphragm 70. In addition, although the diaphragm shown in FIG. 7A and FIG. 7B is a quadrilateral, in fact, the diaphragm can also be designed as a polygon with more sides as needed, and at least one set of two non-adjacent sides can be appropriately curved to obtain structures corresponding to the curved areas 710 and 720.

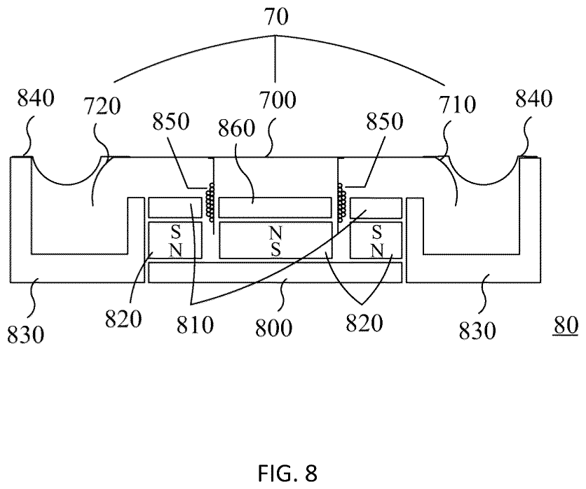

Please refer to FIG. 8, it shows a partial structure diagram of the speaker of the present invention. The diaphragm shown in FIG. 7A or 7B may be employed for the speaker 80, however, only the flat area 700 and the curved areas 710 and 720 are shown in FIG. 8. As shown in FIG. 8, the speaker 80 includes a back plate 800, a washer 810, a permanent magnet 820, a frame 830, a surround 840, and a voice coil 850, a top iron plate 860 and a diaphragm 70. The flat area 700 of the diaphragm 70 completely covers the permanent magnet 820 and even covers the part of the outer frame 830 that is in contact with the permanent magnet 820. Therefore, the diaphragm 70 will not contact to the stationary components in the speaker 80, such as the back plate 800, the washer 810, the permanent magnet 820 and the outer frame 830, but it only contacts with the movable components in the speaker, for example, the surround 840 and voice coil 850. The curved areas 710 and 720 can be received within the space below the surround 840, so the overall thickness of the device will not be increased.

It should be noted that the flat area 700 of the aforementioned diaphragm 70 may include the three-dimensional curved surface as shown in FIGS. 2A to 2F, FIGS. 3A to 3B instead of flat surface without any three-dimensional structure.

Through the embodiments provided in the above aspects, those who in the technical field may combine all or a part of the features to make corresponding diaphragms. With the creativity provided by the present invention, other materials, three-dimensional structure and appearances can be introduced as design choices when making the diaphragms, so the speaker can be configurated in various occasions, and the appearance can be more compatible with the surrounding environment without being obtrusive.

While various embodiments of the present invention have been described above, it should be understood that they have been presented by a way of example and not limitation. Numerous modifications and variations within the scope of the invention are possible. The present invention should only be defined in accordance with the following claims and their equivalents.

What is claimed is:

1. A diaphragm for a speaker, comprising:
a lower surface area;
a central area formed on said lower surface area;
an upper surface area formed on said central area;
wherein said upper surface area, said central area and said lower surface area includes homogeneous amorphous materials; and wherein said diaphragm includes a stress distribution changing with a depth from a surface to a center of said diaphragm.

2. The diaphragm of claim 1, wherein a first thickness of said diaphragm is less than or equal to 50 microns and greater than or equal to 0.1 microns.

3. The diaphragm of claim 2, wherein a second thickness of said upper surface area is less than or equal to 20 microns and greater than or equal to 0.01 microns, a third thickness of said central area is less than or equal to 49.9 microns and greater than or equal to 0.02 microns, and a fourth thickness of said lower surface area is less than or equal to 20 microns and greater than or equal to 0.01 microns.

4. The diaphragm of claim 1, wherein a part or all of said upper surface area or said lower surface area includes a roughened surface for reducing surface acoustic wave reflection and reducing weight.

5. The diaphragm of claim 1, wherein a coating layer formed on a part or all of said upper surface area, said lower surface area or the combination for increasing a damping of said diaphragm.

6. The diaphragm of claim 5, wherein said coating layer includes aluminum, nickel, copper or diamond.

7. The diaphragm of claim 5, wherein said coating layer includes polymer or resin.

8. The diaphragm of claim 1, wherein said diaphragm includes a flat area and at least two side areas located on different sides of said flat area, and wherein said at least two side areas are bent to form cured areas.

9. The diaphragm of claim 1, further comprising another diaphragm, and a low-density core layer disposed between said diaphragm and said another diaphragm.

10. The diaphragm of claim 1, wherein said diaphragm includes a continuous wave structure, an amplitude D is equal to or greater than 1/10 of said first thickness of said diaphragm, and a peak-to-peak length λ is equal to or greater than 2 times said first thickness of said diaphragm.

11. A diaphragm for a speaker, comprising:
a lower surface area;
a central area formed on said lower surface area;
an upper surface area formed on said central area;
wherein said upper surface area, said central area and said lower surface area includes homogeneous amorphous materials; wherein said diaphragm includes a stress distribution with a depth from a surface to a center of said diaphragm; and
wherein a part or all of said upper surface area or said lower surface area includes a roughened surface for reducing surface acoustic wave reflection and reducing weight.

12. The diaphragm of claim 11, wherein a first thickness of said diaphragm is less than or equal to 50 microns and greater than or equal to 0.1 microns.

13. The diaphragm of claim 12, wherein a second thickness of said upper surface area is less than or equal to 20 microns and greater than or equal to 0.01 microns, a third thickness of said central area is less than or equal to 49.9 microns and greater than or equal to 0.02 microns, and a fourth thickness of said lower surface area is less than or equal to 20 microns and greater than or equal to 0.01 microns.

14. The diaphragm of claim 11, wherein a coating layer formed on a part or all of said upper surface area or said lower surface area or the combination thereof for increasing a damping of said diaphragm.

15. The diaphragm of claim 14, wherein said coating layer includes aluminum, nickel, copper or diamond, polymer or resin.

16. The diaphragm of claim 11, wherein said diaphragm includes a continuous wave structure, an amplitude D is equal to or greater than 1/10 of said first thickness of said diaphragm, and a peak-to-peak length λ is equal to or greater than 2 times said first thickness of said diaphragm.

17. A composite diaphragm for a speaker, comprising:
a first diaphragm and a second diaphragm, and a core layer formed between said first diaphragm and a second diaphragm; and
wherein each one of said first diaphragm and said second diaphragm includes: a central area formed on said lower surface area; an upper surface area formed on said central area; wherein said upper surface area, said central area and said lower surface area includes homogeneous amorphous materials.

18. The composite diaphragm of claim 17, wherein each one of said first diaphragm and said second diaphragm includes: a continuous wave structure, an amplitude D is equal to or greater than 1/10 of a thickness of said first diaphragm or said second diaphragm, and a peak-to-peak length λ is equal to or greater than 2 times said thickness of said first diaphragm or said second diaphragm.

19. The composite diaphragm of claim 17, wherein a coating layer formed on a part or all of said upper surface area or said lower surface area or the combination thereof for increasing a damping of said composite diaphragm.

20. The diaphragm of claim 19, wherein said coating layer includes aluminum, nickel, copper or diamond, polymer or resin.
